(19) United States
(12) Patent Application Publication
(10) Pub. No.: US 2005/0199747 A1
(43) Pub. Date: Sep. 15, 2005

(54) Implementation and application of phase change in a fluid flowing through a nozzle

(76) Inventor: Brian P. Roarty, Los Altos, CA (US)

Correspondence Address: GEORGE S. COLE, ESQ., 495 SEAPORT COURT, SUITE 101, REDWOOD CITY, CA, 94063, US

(21) Appl. No.: 10/797,255

(22) Filed: Mar. 10, 2004

(51) Int. Cl. B05C 1/00

(52) U.S. Cl. 239/135

(57) ABSTRACT

Method and system for implementing and applying a phase change in a fluid flowing through a nozzle, converting an incompressible fluid flowing into the inlet and through the throat of a nozzle to a compressible state by the exhaust through promotion of a phase change in the throat of the nozzle. The phase change relies upon energy added to the fluid at the throat. The system converts the energy of the induced phase change to mechanical energy through various means.

### FIELD OF THE INVENTION

This invention relates to a system for making, and making use of, a phase change in a fluid moving through a nozzle. The prior art fully teaches multiple alternative variations on how to provide, pump, and recirculate the fluid and how to translate theoretical work from the heat transfer within the nozzle to real work outside the system.

### BACKGROUND OF THE INVENTION

Conventional nozzles are routinely divided between two nozzle classes, one for incompressible fluids and the second for compressible fluids. Each of these classes of fluids behaves somewhat differently as it flows through a nozzle, where the area of a surface perpendicular to the flow vector reduces to the narrowest (for incompressible fluids) and then increases again (for compressible fluids).

Absent substantial change in any thermodynamic flow variable, the velocity of an incompressible fluid increases as the fluid approaches the throat (i.e. within the inlet section) and achieves a local maximum velocity at or near the throat. In contrast, under selected conditions a compressible fluid may achieve a special value of velocity (e.g., sonic speed in the fluid) at or near the throat, while the fluid velocity may be greater than this special value in the exhaust section.

A liquid fluid which is incompressible may become compressible if it changes phase, either as a partial mixture of liquid and gas or as a completely phase-changed gas. A nozzle arrangement whereby the fluid flowing through the nozzle is incompressible on one side of the throat, experiences a phase change and becomes compressible, with a resultant expansion in volume, as it passes through the throat into the exhaust, may manifest distinct features and advantages in energy usage.

The amount of energy required to induce a phase change is called the heat of transformation, which, for a mass m of a pure substance, is given by the equation Q=mL, where L is the Latent Heat of the substance and depends on the nature of the phase change as well as the properties of the substance. Lᵥ is the heat of vaporization, or the energy needed to transform a liquid to a gas. For water (H₂O), Lᵥ is 2.26×10⁶ J/kg). Introductory physics texts may not include or mention as a property of the substance that it is at a normal pressure of 1 atmosphere; i.e. they may ignore the conditions of the environment. Introductory physics texts will at least mention the three main means of heat transfer as conduction, convection, and radiation.

Classical mechanics fails to accurately consider the quantum-mechanical reality of molecular activity, as it presumes no change in the vibrational state of the molecule. This is chiefly because the separation between adjacent vibrational energy levels for such a simple molecule as H₂ is about ten times the average kinetic energy of the molecule at room temperature and normal pressure. Any translation of an increase in vibrational energy level into kinetic energy would release a different inherent energy storage.

With fluids and gases, both heat and work depend on the process by which a system moves between states; the start, intermediate, and final state, and the pressure, temperature, and volume, all interact. Since the basic formula expressing the work done by a gas is an integral which depends upon the pressure and volume, varying any or all of these affects the calculation of the final result. This formula is:

$$W = {\int }_{Vi}^{Vf} P ⅆ V \qquad Eq . 1$$

where W is the measure of Work done the by gas, Vᵢ is the initial volume, V_{f} is the final volume, P is the Pressure, and dV is the change in Volume between Vᵢ and V_{f}. In a cyclic process a first approximation of the work potentially made available equals the heat transferred into a system. See, e.g. Physics for Scientists and Engineers, 3d Edition, R. A. Serway, 1986, 1990, 1992, Harcourt Brace Jovanovitch, ISBN 0-03-096027-4, p. 550-551.

What is needed is a nozzle with appropriate material properties that supports incompressible flow upstream of, and compressible flow downstream of, a nozzle throat, provides additional energy within the throat to support phase change as part of a fluid flow through the throat into the exhaust, and transforms the resultant energy into a useful form.

### SUMMARY OF THE INVENTION

These needs are met by the present embodiment of the invention, which provides a system that has a fluid F moving through the system, a nozzle with an inlet, a throat, and an exhaust, which nozzle further produces in the fluid F moving through the nozzle a phase change from an incompressible to a compressible state, and which system finally includes means to add energy at the throat and exhaust to the fluid F inducing a phase change therein and converting the result into useful, principally mechanical, work. In the preferred embodiment, the fluid F is a liquid already at or near its boiling point when it enters the inlet. Stimulating means begin converting the fluid F from an incompressible to a compressible state with an accompanying change of phase by adding energy, directly to the fluid or indirectly from the nozzle wall, while the fluid F is passing through the throat. As the fluid F passes out of the throat and into the exhaust the nozzle may further promote the conversion and phase change by further addition of energy, by the volumetric change of the nozzle and resulting pressure change in the fluid F, or by all together.

The additional energy added to the fluid F may be provided by electrical stimulation of a portion of the throat adding heat directly to the fluid F, inducing a low energy nuclear reaction (LENR) within the nozzle, using conduction and convection to heat the fluid F, solar energy, an energy-releasing chemical reaction, or any combination thereof. The phase change may be further supported by a surfactant in the fluid F that promotes and enhances the low energy nuclear reactions in the nozzle. In further embodiments, to enhance the conversion and phase change of the fluid F, the system may vary the stimulation to affect the timing and power of the conversion and phase change of the fluid F.

The energy of the fluid flow out of the exhaust may be transformed into mechanical energy by direct thrust from the exhaust, by indirect thrust where at least one exhaust is off the rotational axis and points tangential to the rotational axis, or by directing the exhaust flow through a turbine. These implementations are scalable over a wide range of applications by varying the number and size of nozzles incorporated.

### BRIEF DESCRIPTION OF THE DRAWINGS

FIG. 1 is a planar cross-section of a nozzle.

FIG. 2A is a planar cross-section of an alternative nozzle with alternative material layering.

FIG. 2B is a three-dimensional cross-section of a nozzle embodying the alternative material layering of FIG. 2A.

FIG. 3 is a planar cross-section of a nozzle showing the means for transferring energy directly to the fluid in the throat; the control and support wiring are not shown since they are known in the prior art.

FIG. 4 is a planar cross-section of a nozzle showing the means for transferring energy directly to the fluid in the exhaust; again, the control and support wiring are not shown since they are known in the prior art.

FIG. 5 is a cut-away, three-dimensional cross-section of a nozzle embodying direct energy transference means embedded in the throat as shown in FIG. 3; again, the control and support wiring are not shown since they are known in the prior art.

FIG. 6 is a planar cross-section of a nozzle showing the means for transferring energy indirectly to the fluid embedded between the structural core and the heat transference block; again, the control and support wiring are not shown since they are known in the prior art.

FIG. 7 is an example of a phased electrical stimulation where the intensity of the electrical stimulus periodically jumps between a low and high state.

FIG. 8 is an example of a scaling increase in electrical stimulation where the intensity of the electrical stimulus periodically changes from a low to a higher state, then back to the low state, then back to a yet higher state, increasing with each upward jump a number of times (in this example, 4), rests, and then the cycle repeats.

FIG. 9 is a view of the exhaust feeding into a turbine.

FIG. 10 is an external view of a system with a number of nozzle exhausts, each of which is off-set from the axis of rotation and pointing tangential to the axis of rotation, by which directed thrust from the exhaust can be converted into rotary motion.

FIG. 11 is a flat nozzle where the change in volume occurs in the X-Y plane, as might be most suitable for a microengineering or nanoengineering, molecular-level construction, showing the means for transferring energy directly to the fluid in the exhaust; again, the control and support wiring are not shown since they are known in the prior art.

FIG. 12 is a three-dimensional view of a cylindrical nozzle embodying a number of vanes extending into the fluid flow from the heat transference block towards and parallel to the fluid flow z-axis, thereby exposing more surface area for heat transference to the fluid flow F.

### DETAILED DESCRIPTION OF THE DRAWINGS

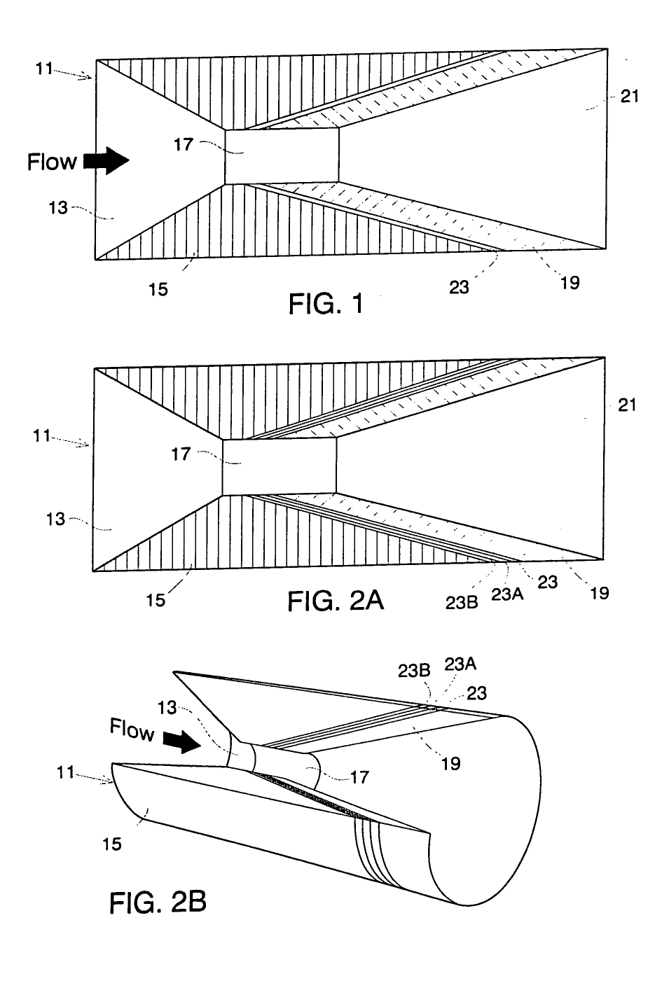

FIG. 1 is a planar cross-section view of a nozzle 11 through which flows a fluid F (not shown), with the z-axis being both the direction of flow of the fluid F and passing from the left to right side of the view. The nozzle 11 includes an inlet 13, a throat 17, and an exhaust 21. The nozzle may be composed of multiple layers of materials from inlet to exhaust including a structural core 15, a heat transference block 19, and an insulating layer 23 separating the structural core 15 from the heat transference block 19. Both the throat 17 and exhaust 21 may encourage and support the phase change of the fluid F.

FIG. 2 is two views of a single side of the nozzle. FIG. 2A is, like FIG. 1, a planar cross-section view paralleling the z-axis of the fluid flow. FIG. 2A shows the structural core 15 which first defines the inlet 13 and the initial portion of the throat 17, where it meets the insulating layer 23 that separates the structural core 15 from the heat transference block 19. FIG. 2A additionally shows the insulating layer 23 subdivided into multiple sub-layers having different insulating capacities (e.g. 23A, electrical; 23B, thermal) in order to limit both electrical and thermal energy transference between the structural core 15 and the heat-transference block 19. FIG. 2B is a three-dimensional view of a nozzle with a cylindrical interior also shows that the insulating layer 23 subdivided into multiple sub-layers 23A, 23B with different insulating capacities as in FIG. 2A.

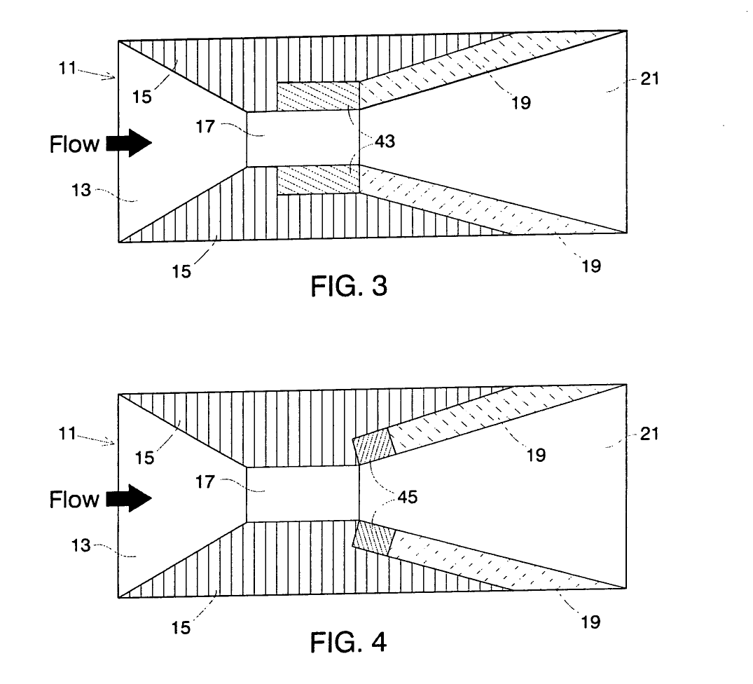

FIG. 3 is, like FIG. 1, a planar cross-section view of a nozzle 11 with the z-axis being both the direction of flow of the fluid F and passing from the left to right side of the view. The nozzle 11 in this embodiment includes in the throat 17 embedded direct excitation means 43 for transferring energy to the fluid F to induce a phase change by the exhaust 21; again, the control and support wiring are not shown.

FIG. 4 is, like FIG. 3, except that in this embodiment the embedded direct excitation means 45 for transferring energy directly to the fluid F to induce a phase change are at the left-most end of the exhaust 21; again, the control and support wiring are not shown.

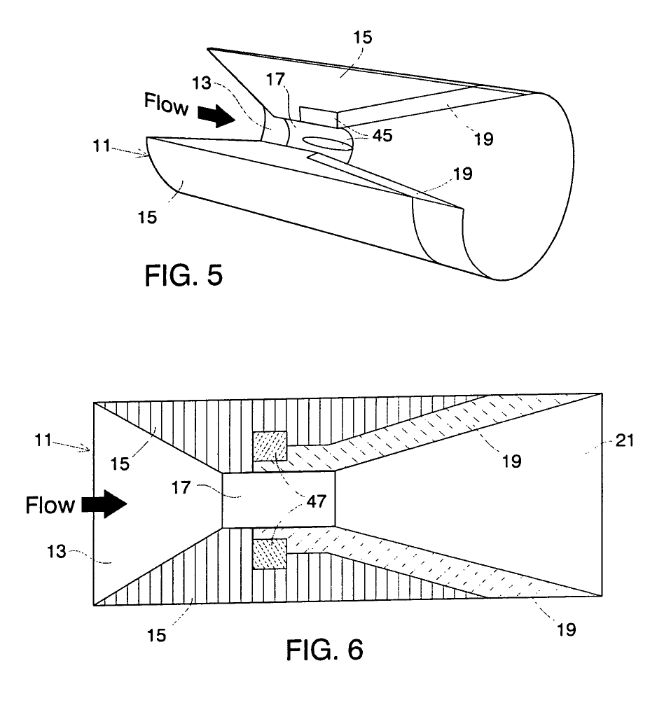

FIG. 5 is a cut-away, three-dimensional cross-section of a nozzle embodying the embedded direct excitation means 45 in the throat 21 as shown in FIG. 3.

FIG. 6 is a planar cross-section view of a nozzle 11 with the z-axis being both the direction of flow of the fluid F and passing from the left to right side of the view. The nozzle 11 in this embodiment includes in the throat embedded indirect excitation means 47 for transferring energy to the heat transference block 19 from which the energy passes into the fluid F to induce a phase change therein; again, the control and support wiring are not shown.

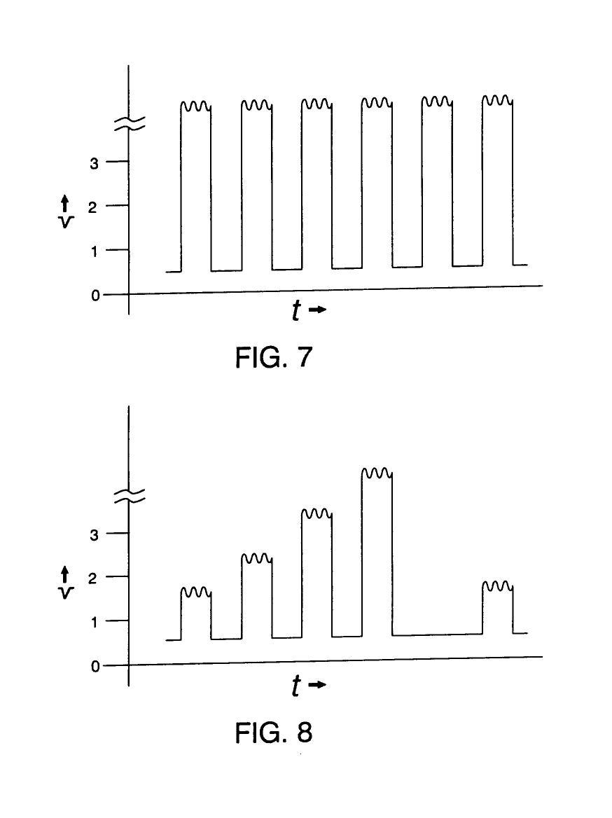

FIG. 7 shows a pattern of electrical stimulation, where the voltage pulses between low and high values (the v axis) in a timed pattern of identical sinusoidal pulses (the t axis). The values are not absolute but exemplar to show the nature of the pattern.

FIG. 8 shows a pattern of electrical stimulation, where the voltage pulses between low and higher values (the v axis) in a laddered increase over time (the t axis), which pattern repeats periodically after a rest. The values are not absolute but exemplar to show the nature of the pattern.

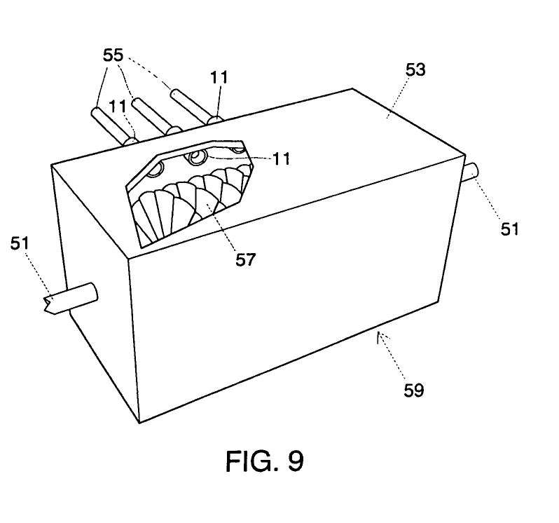

FIG. 9 shows a further embodiment in which the system has at least one nozzle 11 directing its exhaust 21 into a turbine 59, in which a set of vanes 57 are spun by the fluid F leaving the nozzles; the containment chamber 53 conserves the fluid F while the turbine axis 51 provides mechanical rotation for further transmission outside the system; again, the control, recapture, recirculation, and pumping means for the fluid F are not shown as these are well known in the prior art.

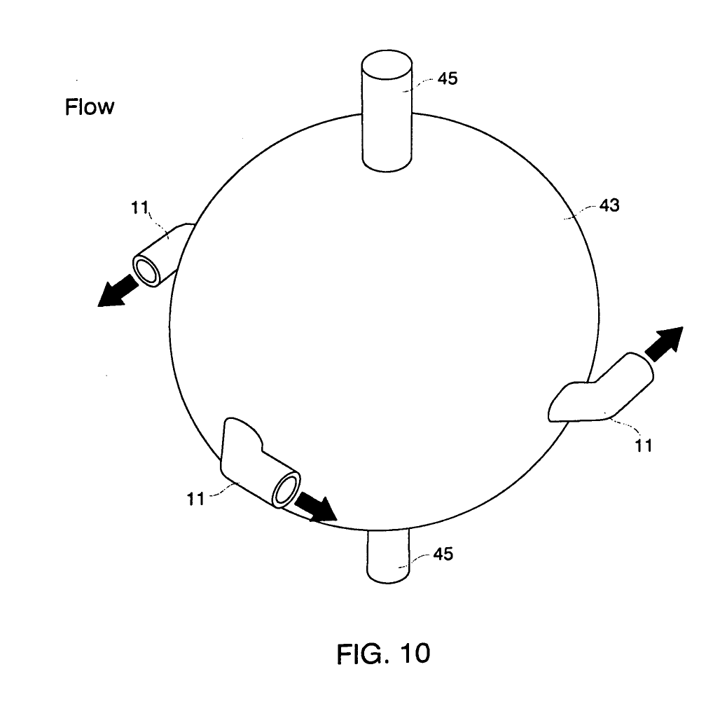

FIG. 10 shows a further embodiment in which the system uses a set of nozzles equally offset by 90° (11-1, 11-2, and 11-3, the 3 of a set of 4 being visible) which are both off-set from and directed tangentially to the rotational axis running between the top and bottom ends of the through-pipe 45, thereby producing a rotational spin to a integral mass forming a flywheel 43 from which mechanical work can be extracted. Not shown, as well understood in the prior art, are recapture and recirculating mechanisms for the system, the means for transferring the rotational energy of the flywheel 43, and the control wiring, as these are well known in the prior art.

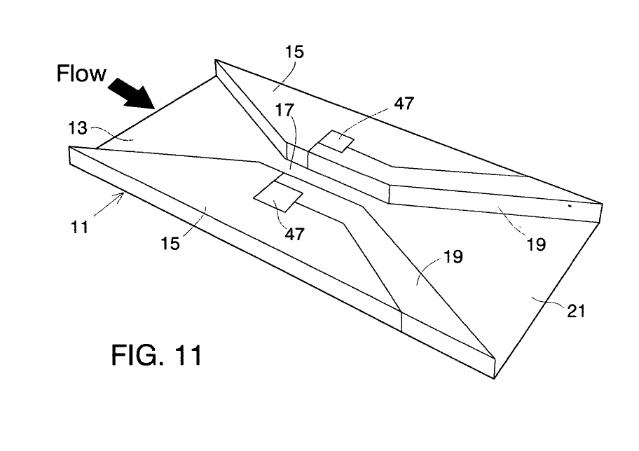

FIG. 11 shows a non-cylindrical, nearly flat nozzle where the majority of the changes in the volume of the fluid F (not shown) flowing through the nozzle occur both between the inlet 13, throat 17, and exhaust 21, and in a single plane perpendicular to the z-axis of the flow. The embedded direct excitation means 47 are in the throat 17. This form of nozzle may be preferable for microengineered or nanoengineered nozzles where the layers of materials forming the structural core 15 and the heat transference block 19 are better measured in molecular rather metric terms.

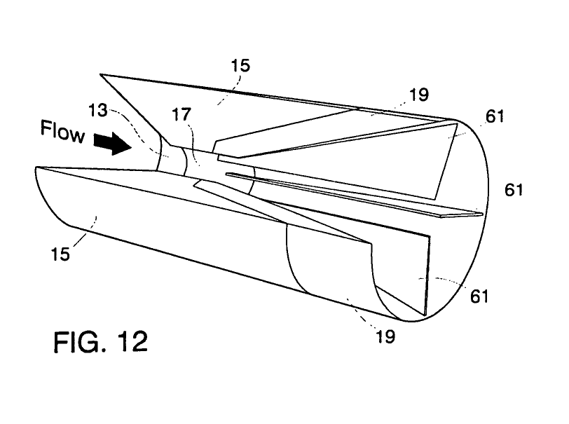

FIG. 12 is a three-dimensional view of a cylindrical nozzle with an inlet 13, throat 17, and exhaust 21, built out of a structural core 15 and heat transference block 19, which incorporates at least one vane 61 extending into the fluid flow from the heat transference block 19, said vane oriented parallel to the z-axis, thereby exposing more surface area for heat transference to the fluid flow F while reducing the blockage of the fluid flow by the leading edge of the vane 61.

### DETAILED DESCRIPTION OF THE INVENTION

The system comprising the present embodiment of the invention includes a nozzle, a fluid F moving through the nozzle, and means for inducing a phase change in the fluid F within the nozzle through a heat transfer into the fluid F within the nozzle. In the preferred embodiment of the invention, the system further comprises means for transforming the flow of fluid F from the nozzle into work that can be transferred outside the system.

External condensation and recirculating elements, filtering, control and timing means, and mechanical energy transmission means are well known in the prior art and are neither shown nor claimed as part of this invention; however, its application and use thereof in combination are not so disclaimed and may be additional parts to each of the embodiments herein.

The nozzle 11 comprises an inlet 13, a throat 17, and an exhaust 21, where the interior area perpendicular to the fluid flow axis (the z-axis) decreases to a minimum, remains constant, and then increases again. The nozzle starts with a structural core 15, and the preferred embodiment further incorporates an insulating layer 23, means embedded within the nozzle for transferring energy into the fluid F and inducing a phase change in the fluid F (directly 43, 45, or indirectly 47), and a heat transference block 19; a combination of these elements extending from at least a portion of the throat 17 through the exhaust 21. The interior form of the nozzle depends on the shaping of the inner surfaces of the structural block 15, insulating layer 23, means for transferring energy directly (43, 45) and heat transference block 19, as seen in FIGS. 1-6, further detailed hereafter.

FIG. 1 is a schematic view of a nozzle 11. The inlet 13 is defined by a first block that forms the structural core 15 of said nozzle, the structural core 15 being of solid material with decreasing cross sectional area A(z) perpendicular to the fluid flow, i.e. for increasing values of a coordinate z along a z-axis for the system. (In FIG. 1 the z-axis is aligned with the left-right axis of the view). The throat 17 is that part of the nozzle at which the cross sectional area A(z) of the structural core 15 reaches and keeps a minimum value; in a further embodiment the throat may additionally be formed by any combination of the structural core 15, a embedded direct excitation element 43 (FIG. 3), and a heat transference block 19. The exhaust 21 is where the cross sectional area A(z) now increases above its minimum value through the throat. The exhaust 21 may be formed by the structural core (not shown) or, preferably, is formed by the heat transference block 19 as shown in FIG. 1, alone or in combination with the embedded direct excitation means 45 (FIG. 4) and the insulating layer 23 (FIG. 1). The structural core 15 and the heat transference block 19 in the preferred embodiment of the invention are separated by an insulation layer 23.

Within the inlet 13, the fluid F is preferably incompressible and maintained at or near conditions for a change of phase (e.g., from liquid to gas or vapor); so it could be near or at its boiling temperature but above its boil pressure (and thus in a superheated state). The fluid F in the preferred embodiment is moved into and through the system 11 by a pump (not shown) or by centrifugal forces provided by motion outside the system 11; and the fluid may be recondensed and/or replaced by those means already well-known in the art, also not shown.

As the fluid F passes through the throat 17 and into the exhaust 21, heat and/or thermal energy particles from the heat transference block 19 raise the energy level of the fluid F by ΔE per unit volume and promote a change of phase of the fluid in this region. The energy level increment ΔE should be at least equal to, and preferably greater than, the phase change energy increment ΔE (phase, i.e. Lᵥ) per unit volume required to cause a phase change in the fluid F. It may be appropriate, therefore, to provide one or more additional energy sources within the throat 17 and/or within the exhaust 21 to ensure a change of phase of the fluid F in those regions. As a result of the phase change, the fluid F becomes compressible within at least a portion of those regions so that the fluid flow behavior is changed substantially therein.

The fluid F may initially be a liquid, such as water, with a nominal or substantial amount of deuterium (D) present, as HDO or D₂O, or the fluid F may be another liquid that has a substantial portion of its H atoms replaced by D atoms (each containing one proton and one neutron). Alternatively, the fluid F may be an electrolytic liquid having one or more conductive salts therein, such as lithium sulfate or another suitable salt of lithium, boron, aluminum, gallium, indium or thallium.

As the viscosity of the fluid may effect the system and thereby affect the efficiency of the heat transference, the efficiency of the LENR, or the efficiency of the phase change, in a further embodiment of the invention a wetting agent or surfactant is included in the fluid F to promote better interaction between the fluid F and the surface(s) of the nozzle, particularly the throat 17, the exhaust 21, and the heat transference block 19. The preferred surfactant belongs to a class that consists of short chain molecules from five to fifty atoms long and containing an extra ion. The preferred surfactant will not react with the fluid F, e.g. the lithium or other salt.

The heat transference block 19 may be porous, sintered, have micro-cracks therein, or foraminous with the channels both parallel to the z-axis and with open connection to the inner surface of the heat transference block, to encourage free neutrons to move between the fluid F and the second block material, to encourage or replenish or transfer energy from low energy nuclear reaction and/or other stimuli; or to encourage the conductive and convective transference of energy between the heat transference block 19 and the fluid F.

The insulation layer 23 is optional and may include thermal insulation, electric insulation, or a combination thereof; in a further embodiment there is both a first sub-layer 23A of electrical insulating material, plus a second sub-layer 23B of thermal insulation material, as illustrated in FIGS. 2A & 2B. Optionally, the sub-layers 23A and 23B, may be combined in a single insulation layer 23. The insulation layer 23 suppresses or eliminates exchange of electrically charged particles and exchange of most thermal energy between the structural core 15 and the heat transference block 19.

Material for the structural core 15 may be any suitable solid material, such as a metal, a sintered metal, an alloy, a ceramic, or a carbon composite that resists wear or erosion from the fluid F passing through the inlet 13 and throat 17. Material for the heat transference block 19 in the preferred embodiment incorporates a material that forms a metal hydride and enables, supports, or encourages a Low Energy Nuclear Reaction (LENR) within the heat transference block 19 and thereby provides thermal energy (heat) that is transferred to the fluid F at the surface(s) of the heat transference block 19. In the preferred embodiment of this invention, the metal forming the heat transference block 19 is palladium. This heat transference block may be only a plating on the inner surface of the nozzle a few molecules thick.

Low energy nuclear reactions are used in preference to, or in conjunction with, other sources of energy because their energy densities are far greater than those of other sources, and because their energy is released in the nozzle where it is needed to change the phase of the fluid rather than being conveyed to the nozzle by other means such as an electric current, electric field, or radiation.

Other suitable materials for the heat transference block 19 include lanthanum, praseodymium, cerium, titanium, zirconium, hafnium, vanadium, niobium, tantalum, nickel, thorium, protactinium, and uranium. Authority for the inclusion of those elements in italics within this group is found in a book entitled “Inorganic Hydrides” by B. L. Shaw, published by Pergamum Press, 1967. Authority for inclusion of the others comes from their presence in the same column of the Periodic Table of Elements, which groups elements by functional similarities.

Energy may be introduced into the fluid F by direct or indirect means. Direct energy transfer to the fluid F may come through the embedded direct excitation means (43, 45); these may be a ferrous material in which an electromagnetic field induces heat; a resistive material heated by passing a current through it; or the nozzle may have embedded in it either a microwave or a laser whose emission directly affects the fluid F; or the system may include an anode and cathode and a fluid F reactive to electrical stimulation and using the fluid F pass a current between the anode and the cathode. The laser emission or current may be constant, periodic, or varying. Any combination of such directly stimulating means may be incorporated in the system.

Indirect means for introducing energy into the fluid F include the embedded indirect excitation means (47) which enable, support, or encourage a Low Energy Nuclear Reaction (LENR) within the heat transference block 19; these embedded indirect excitation means (47) may include electrical stimulation of the heat transference block, laser stimulation of the heat transference block, or any combination thereof. If the means which enable, support, or encourage a low-energy nuclear reaction within the heat transference block are electrically stimulating the heat transference block, the system will include an anode, use the heat transference block as an cathode, and pass an electric current between the anode and the cathode.

In one embodiment, when an electric current is used to stimulate the LENR, the electric current may have a time-varying waveform consisting of pulses having a baseline near 1 volt and amplitude sufficient to separate the bond between the hydrogen and oxygen in the water molecule. The pulses carry a modulation that is sinusoidal or nearly so. In a further embodiment, the pulses may increment up in amplitude in a staircase manner, until ceasing, providing a stimulus of increasing stimulation followed by relaxation. Also, provided that the anode is composed of the same metal as the cathode, the current flow may briefly reverse direction, although care must be taken that it not corrode the cathode by doing so. The resulting waveform resembles the acoustic waveform created by percussion instruments and may effect both vibration and electrical stimulation of the LENR; it is as if one obtained the LENR by “beating God's drum”.

If the system uses electrical stimulation, the fluid F must be either weakly or strongly conductive, and the anode should not be part of the nozzle since the anode will dissolve over time as a natural result of electrolysis.

If the means for inducing a low-energy nuclear reaction within the heat transference block are laser stimulating the heat transference block the nozzle will include at least one embedded laser, possibly fabricated with techniques similar to those of semiconductor devices whose emission affects the heat transference block. Any combination of such indirectly stimulating means may be incorporated in the system.

Any combination of directly and indirectly stimulating means may be incorporated in the system.

In another embodiment, illustrated in FIG. 12, a nozzle 111 includes one or more vanes 61, located in the throat 17 and/or in the exhaust 21 and oriented so that at least one surface plane of the vane 61 is approximately parallel to a local flow direction of the fluid F through the nozzle. The vane 61 is made of a material similar to or identical to the material of the heat transference block 19 that supports low energy nuclear reactions within the material. A vane 61, thus presents more surface area to the fluid F and thus has the potential to contribute more thermal energy to the fluid F than would a flat interior surface of the heat transference block 19.

There are a number of means for transforming a heat-exchange that produces directed steam into useful work well known in the prior art. First among these is using the exhausted fluid in a steam jet to propel the entire system directly, according to Newton's First Law of Motion F=ma. This requires a constant replenishment of the fluid, and can propel a vehicle. A second means for transforming a heat-exchange that produces directed steam into useful work is to direct the exhaust into a turbine, whose spinning produces mechanical and/or electrical power, as shown in FIG. 9. Such a turbine may, particularly at the human or larger machine scale, have vanes with differential surfaces such that the Bernoulli effect (‘lift’) causes the vanes to rotate. Another alternative, feasible due to material property limitations at the smaller and micro scales, is to have the steam directed across the surface(s) of the turbine's vane(s), preferably as far offset from the turbine's axis of rotation as is possible, thereby using the friction of the passage of the steam to spin the vanes and thus the turbine. A third means off-sets the exhaust from the z-axis and directs the exhaust tangentially to the z-axis, thereby transforming the heat-exchange which forms the steam jet into mechanical rotary motion as shown in FIG. 10. Again, the condensation, recirculation, filtering, control and timing elements are not shown as these are known to the prior art.

As shown in FIG. 10, at least one nozzle (if more, they will be equally distributed about a circle) may be placed with its exhaust (21-1, 21-2, and 21-3) offset from the z-axis (which in FIG. 10 goes between the top and bottom of the view) and aimed tangentially to the z-axis; this nozzle thereby forms part of a rotatable body 43 that rotates on bearings about a central axis 45 and serves as a flywheel. In this embodiment, the fluid F that exits from the exhaust of one or more nozzles 21ᵢ (i=1, 2, . . . ) is directed against an ambient atmosphere and causes rotation of the rotatable body 43 about the central axis 45, similar to rotation of a fireworks “pinwheel.” The nozzle embodiments shown in FIGS. 1-6 provide increased total fluid energy (kinetic, thermal, etc.) that is in turn converted to rotational or other kinetic energy as the fluid F exits from the exhaust 21 of a nozzle 11 (or 21). Discharge from two nozzles 21ᵢ (i=1, 2) may be continuous, or the nozzle discharges may be synchronized so that each nozzle is “pulsed” during a different time interval, where time intervals from two nozzles either partly overlap or are spaced apart and non-overlapping. The stimulation of the heat transference block 19 may be pulsed and timed by inductive pickup governed by location as the rotor rotates. The rotor system shown in FIG. 10 is easily scaled up or down by changing the number and/or size of the nozzles and exhausts 21, used in the system. The rotor system shown in FIG. 10 can be used as the basis for an engine. Recirculating, recondensing, filtering, timing and control elements, like the fluid F, are not shown. The nozzles described herein are as fundamental to such an engine as pistons are to reciprocating engines and blades are to turbines. Such an engine can be used to drive a variety of rotational mechanisms, including, but not limited to, electric generators, wheels, propellers, screws, pumps, compressors, turbines, and the compressor stages of turbines.

### BRIEF DESCRIPTION OF THE PREFERRED EMBODIMENT

In the preferred embodiment of this invention, the nozzle 11 is comprised of an inlet 13, a throat 17 (which is formed by a combination of the structural core 15, the insulating layer 23 which itself comprises a lamination of both electrically and thermally insulating materials, and the heat transference block 19 made of palladium), and an exhaust 21. Embedded in the nozzle between the structural core 15 and the heat transference block 19 is at least one anode (not shown) which passes a current through the heat transference block 19 in pulses that increment up in amplitude in a staircase manner (FIG. 8), until ceasing, providing a stimulus of increasing stimulation followed by relaxation. Also embedded in the nozzle is at least one laser (47) whose emission affects the heat transference block 19, illluminating it from the side adjacent to the structural core 15 and parallel to the fluid flow, and is pulsed. The fluid F incorporates lithium salt, a short-chain (5-10 atoms) surfactant having an extra ion that is non-reactive with the surfactant, and deuterium; the fluid F is also at its vaporization point at the inlet 13. The fluid F flows through the system into the inlet 13, through the throat 17, where a phase change is induced and the fluid changes from an incompressible state to a compressible state as it passes into and through the exhaust 21. The system offsets the nozzles 11 from the z-axis such that the fluid F as it flows through the exhaust is directed tangentially to the z-axis in a rotor system as shown in FIG. 10. The fluid F is recaptured, recondensed, and recirculated back to the inlet 13.

The scope of this invention includes any combination of the elements from the different embodiments disclosed in this specification, and is not limited to the specifics of the preferred embodiment or any of the alternative embodiments mentioned above. The claims stated herein should be read as including those elements which are not necessary to the invention yet are in the prior art and are necessary to the overall function of that particular claim, and should be read as including, to the maximum extent permissible by law, known functional equivalents to the elements disclosed in the specification, even though those functional equivalents are not exhaustively detailed herein.

Additionally, the use of multiple exhausts, nozzles, off-set nozzles and exhausts, and turbines, should be read into the claims as the language uses that singular indefinite article (‘a’, or ‘an’), and that usage is, according to practice and prior legal interpretation, not limited to the ordinal, single-unit definition but is synonymous with the permissive phrase ‘at least one’.

1. A system, comprising:
a nozzle having an inlet, a throat, and an exhaust;
a fluid flowing through the nozzle; and,
means for inducing a phase change in the fluid within the nozzle.

2. A system, comprising:
a nozzle having an inlet, a throat, and an exhaust;
a fluid flowing through the nozzle;
means for inducing a phase change in the fluid within the nozzle; and,
means for transforming the flow from the exhaust into work outside the system.

3. A system, comprising:
a nozzle having an inlet, a throat, and an exhaust;
a fluid flowing through the nozzle;
means embedded within the nozzle for directly transferring energy into the fluid and inducing a phase change in the fluid; and,
means for transforming the flow from the exhaust into work outside the system.

4. A system, comprising:
a nozzle having an inlet, a throat, and an exhaust;
a fluid flowing through the nozzle;
means embedded within the nozzle for transferring energy into and heating the nozzle, thereby indirectly transferring energy into and heating the fluid and inducing a phase change in the fluid; and,
means for transforming the flow from the exhaust into work outside the system.

5. A system as in claim 4, wherein the cross-sectional interior volume of the inlet, throat, and exhaust of the nozzle vary only across one plane perpendicular to the axis of fluid flowing through the nozzle.

6. A system as in claim 4, further comprising a surfactant having an extra ion dissolved in the fluid.

7. A system as in claim 6, wherein the surfactant is a short-chain molecule.

8. A system as in claim 6, wherein the surfactant is a short-chain molecule having only 5 to 50 atoms.

9. A system as in claim 6, wherein the surfactant is a short-chain molecule having only 5 to 10 atoms.

10. A system as in claim 6, wherein the fluid includes a lithium salt and the surfactant is non-reactive to the fluid and lithium salt.

11. A system as in claim 10, wherein the nozzle further comprises:
a third block of an insulating material separating the first structural core and heat transference block.

12. A system as in claim 11, wherein the third block further comprises:
a first sub-layer of an electrical insulating material; and,
a second sub-layer of a thermal insulating material.

13. A system as in claim 11, wherein means embedded within the nozzle for transferring energy into and heating the nozzle, thereby indirectly transferring energy into and heating the fluid and inducing a phase change in the fluid further comprise:
a structural core formed of a first material;
a heat transference block formed of a second material, said heat transference block having at least one surface over which the fluid flows and from which heat is transferred from the heat transference block to the fluid; and,
means for inducing a low-energy nuclear reaction within the heat transference block to create heat in the heat transference block.

14. A system as in claim 13, wherein the fluid includes deuterium.

15. A system as in claim 13, wherein the second material is a metal alloy whose principal component comes from the following set of materials: palladium, lanthanum, praseodymium, cerium, titanium, zirconium, hafnium, vanadium, niobium, tantalum, nickel, thorium, protactinium, and uranium.

16. A system as in claim 13, wherein the second material is palladium.

17. A system as in claim 16, wherein the means for inducing a low-energy nuclear reaction within the heat transference block to create heat in the heat transference block further comprise:
an anode; and,
means for electrically stimulating the heat transference block by passing a current between the anode and the heat transference block.

18. A system as in claim 17 wherein the electrical stimulation of the heat transference block varies periodically.

19. A system as in claim 17, wherein the stimulation of the heat transference block occurs in a periodic pattern of increasing impulses.

20. A system as in claim 13, wherein the means for inducing a low-energy nuclear reaction in the heat transference block further comprise at least one laser in the nozzle whose emission is directed against the heat transference block.

21. A system as in claim 20, wherein the laser is capable of variable emission.

22. A system as in claim 16, wherein the means for inducing a low-energy nuclear reaction within the heat transference block to create heat in the heat transference block further comprise:
an anode;
a cathode;
means for electrically stimulating the heat transference block between the anode and cathode; and,
at least one laser whose emission affects the heat transference block.

23. A system as in claim 21, wherein both the laser, and the means for electrically stimulating between the anode and cathode the heat transference block, are capable of variable output.
